(19) United States
(12) Patent Application Publication
(10) Pub. No.: US 2026/0362403 A1
(43) Pub. Date: Nov. 12, 2026

(54) METHOD FOR DETERMINING TIME SLOTS IN A WIRELESS COMMUNICATION SYSTEM

(71) Applicant: PINPOINT GMBH, Chemnitz (DE)

(72) Inventor: Janik KADEN, Chemnitz (DE)

(21) Appl. No.: 19/693,464

(22) Filed: May 31, 2026

Related U.S. Application Data
(63) Continuation of application No. PCT/DE2024/101000, filed on Nov. 25, 2024.

(30) Foreign Application Priority Data
Dec. 19, 2023 (DE) 102023135774.3

(51) Int. Cl. H04W 72/0446

(52) U.S. Cl. CPC H04W 72/0446

(57) ABSTRACT

A method for determining time slots in a wireless communication system configured as a radio network performing synchronization tasks, the communication system including plural network subscribers having transmission functionality, the method comprising including dividing a radio channel provided by the network subscribers into individual time slots (zn) configured to sequentially transmit data by a time division multiplexing method of time division multiple access and each time slot (zn) is occupiable by a network subscriber, wherein each network subscriber with transmission functionality includes a slot selector used by the network subscriber to access the divided radio channel in a time coordinated manner; counting a distance of free time slots (zn) from an occupied time slot (zn) in a first direction from a start time slot in a first counting loop (s1) and storing the respective distance of each time slot (zn) in a first data structure (d1).

### RELATED APPLICATIONS

This application is a continuation of international application PCT/DE2024/101000 filed on Nov. 25, 2024, claiming priority from German patent application DE 10 2023 135 774.3 filed on Dec. 19, 2023, both of which are incorporated in their entirety by this reference.

### FIELD OF THE INVENTION

The invention relates to a method for determining time slots in a wireless communication system, in particular, in a radio network, configured to perform synchronization tasks.

### BACKGROUND OF THE INVENTION

In order to perform radio locating inside buildings, in particular, in interior spaces, networks configured to locate mobile devices are known, wherein the networks use ultra-wide band technology (UWB) for communications between individual network nodes. These locating networks typically include plural stationary reference stations also designated as a beacon or an anchor, forming an infrastructure of an indoor locating environment. This infrastructure facilitates a position determination of movable objects also designated as tags like, for example, tablets or mobile phones.

Radio based data transmission between anchors and between anchors and tags is typically performed through a predetermined transmission channel in an air medium.

Access of the anchors to an existing transmission channel can be controlled by various multiplexing methods. Time division multiple access, TDMA, is a widely used method. Thus, time is divided into plural time slots, and a determination is made in which time slot an anchor is allowed to transmit.

Assigning the anchors to the time slots can be performed in various ways. The time slots can be determined manually before installation, which is not really practical in large installations with many anchors. Additionally, the manually configured system is not flexible when anchors are added or removed during use of the system.

Random assignation of a time slot is a very simple, automated method. Thus, a time slot is random, determined, and a check is subsequently performed whether the time slot is available. In case many of the existing time slots are occupied by anchors already, random assignation may fail frequently, which requires a large amount of computing time. Thus, there is a long-felt need for a more systematic approach.

Transmitted UWB signals are received in the receivers and processed. This process requires processing time in the transmitter as well as in the receiver. An existing transmission channel shall be used as uniformly as possible in order to generate minimum loading. Time slots that are occupied within the transmission channel should therefore be as far apart as possible. However, this is not possible when random assigning time. This is also a disadvantage of manual assignation in addition to lack of flexibility.

The document WO 98/2310682 A2describes a method and a base station system for configuring an interface between a mobile station and a base station of a time multiplex mobile radio system for packet data transmission. Thus, plural time slots are combined in downstream direction to form a signaling block for plural mobile stations. This, however, does not provide optimum spacing between two time slots, which can cause reduced transmission performance and interference in adjacent channels.

The document WO 99/23844 A2 discloses a method and a device for transmitting data packets. The data transmission is performed by time-division multiplexing, wherein the base station transmits a maximum supported data rate to a mobile station in each time slot.

Another time division multiplexing method is known from the printed document DE 696 20 781 T2.

A method for selecting the best receiver antenna from two or more receiver antennas is known from the document DE 691 01 733 T2. This document describes a time division multiplex radio communication system including mobile radio stations and time slots assigned to each respective station, wherein a received signal strength is measured for each antenna during a time slot, wherein the time slot directly precedes a time slot assigned to the respective station, and wherein antenna selection is performed as a function of the signal strengths. Measuring the signal strength and processing the measurement requires additional computing power and computing time.

The document WO 00 74428 A1 relates to a method and a device for allocating radio resources providing sequential time slots in a cellular radio system with minimized signal load in the system. Thus, an assignation of available time slots is performed by looking for free time slots within a frame, wherein time slots are being re-grouped in order to obtain directly adjacent free time slots. Thus, a time distance from a beginning or end of a frame is captured and processed for each time slot. This method requires powerful hardware in order to manage increased computation complexity. Therefore, this solution is not implementable in battery operated microdevices.

### BRIEF SUMMARY OF THE INVENTION

It is an object of the invention to provide a method for determining time slots in a wireless communication system, including assigning a communication device to a time slot, wherein an optimum distribution of the communication devices to existing time slots is performed with minimum possible computation complexity. Furthermore, peak loads during data processing and communication pauses are reduced or avoided.

The object is achieved by the features of the independent claim. Advantageous embodiments can be derived from the dependent claims.

The method relates to determining time slots in a wireless communication system, the communication system including plural network subscribers with transmission functionality, wherein a radio channel provided by the network subscribers is divided into individual time slots for sequential data transmission by time division multiple access and each time slot is occupiable by a network subscriber. According to the invention, each network subscriber with transmission functionality includes a slot selector enabling the network subscriber to access the divided radio channel in a time coordinated manner, wherein a distance from a free time slot to an occupied time slot is counted in a first direction in a first counting loop, starting from a start time slot, and the respective distance of each time slot is stored in a first data structure. Thereafter, counting a distance of free time slots to an occupied time slot is performed in a second direction that is opposite to the first direction in a second counting loop and the respective distance is associated with the time slot and stored in a second data structure. The counting loops are reset to a value of zero for an occupied time slot. The distances of the individual time slots stored in the first and second data structure are multiplied with one another and a multiplication product is stored in a third data structure, wherein a maximum value in the third data structure indicates a maximum distance between two occupied time slots, wherein a time slot with maximum distance is put out as an optimum time slot for data transmission by a network subscriber.

According to an advantageous embodiment, the network subscribers are stationary reference stations, configured as anchors and/or movable objects configured as tags having transmission functionality, wherein each anchor and/or tag has a proprietary time slot configured as a transmission point in time, and wherein the anchors and/or tags select a free time slot.

According to another advantageous embodiment, the communication system includes additional network subscribers without the slot selector, configured as tags without transmission functionality. The slot selector is not required for this configuration of tags since the tags do not actively access the channel.

A start time slot for starting the count is randomly selected in a first embodiment but can also be predetermined. The time loop is continuous and restarted from a predetermined start value for each occupied time slot. A start value of 0 is assigned to an occupied time slot in an advantageous embodiment of the method, an adjacent time slot is assigned a start value of 1. When the counting loop starts with a free time slot, a start value of 1 is assigned to this time slot. The value of the number sequence increases for each time slot by the amount of 1 until an occupied time slot is determined. This occupied time slot is assigned the value of 0, which restarts the count. This applies to the first counting loop as well as to the second opposite counting loop.

Advantageously, an anchor or tag selects the time slot that has the maximum value in the third data structure. When the third data structure includes plural determined maximum values, a random selection of a time slot with a maximum value can be performed in the third data structure. This provides time-balanced network communications by assigning new slots with maximum distance from already occupied slots.

The first data structure, the second data structure, and the third data structure can be integer-type arrays. Advantageously, an occupied time slot is assigned the value of 0 in the data structure. Two variables are used to compute the distances, wherein the first variable, n, indicates a maximum number of time slots and the second variable, M, indicates the position of the time slots already occupied. A computed distance of each time slot to a directly or indirectly adjacent occupied time slot is stored in the third data structure.

Specifying occupied time slots facilitates pre-reserving non-vacant time slots in a simple manner, for example, for system services without adapting the method.

Advantageously, the number of time slots specified by the variable (n) is divided into periodically recurring sections in the form of frames, wherein each frame incudes n time slots. In an advantageous embodiment, the first counting loop can start at a beginning of the frame and count ascending in a direction towards an end of the frame. The second counting loop counts from the end of the frame towards the beginning of the frame. The counting loop is set to 0 when determining an occupied time slot.

The instant method facilitates using battery-operated micro units with small storage and computing complexity. The computing methods only require simple energy and storage efficient computing.

As an additional benefit, a balanced storage and processing load is achieved in the nodes, and long communication pauses are avoided during network synchronization. This is an additional benefit, in particular for UWB networks.

The method according to the invention is suitable for each radio network with synchronization tasks. The method can be used particularly advantageously in UWB networks in order to locate mobile devices.

The method according to the invention achieves time balanced communications, avoiding load peaks when processing the data in the UWB networks. By avoiding long communication pauses, this facilitates achieving or maintaining a high level of synchronization fidelity in the network. This is an important aspect when using UWB networks for locating in particular mobile devices.

### BRIEF DESCRIPTION OF THE DRAWINGS

The invention is subsequently described based on an embodiment with reference to drawing figures wherein:

FIG. 1 illustrates an advantageous time slot assignation and a first counting loop with associated diagram;

FIG. 2 illustrates a diagram according to FIG. 1;

FIG. 3 illustrates an advantageous time slot assignation and a second counting loop with associated diagram;

FIG. 4 illustrates a diagram according to FIG. 3;

FIG. 5 illustrates a multiplication of the first data structure and the second data structure; and

FIG. 6 illustrates a diagram according to FIG. 5.

### DETAILED DESCRIPTION OF THE INVENTION

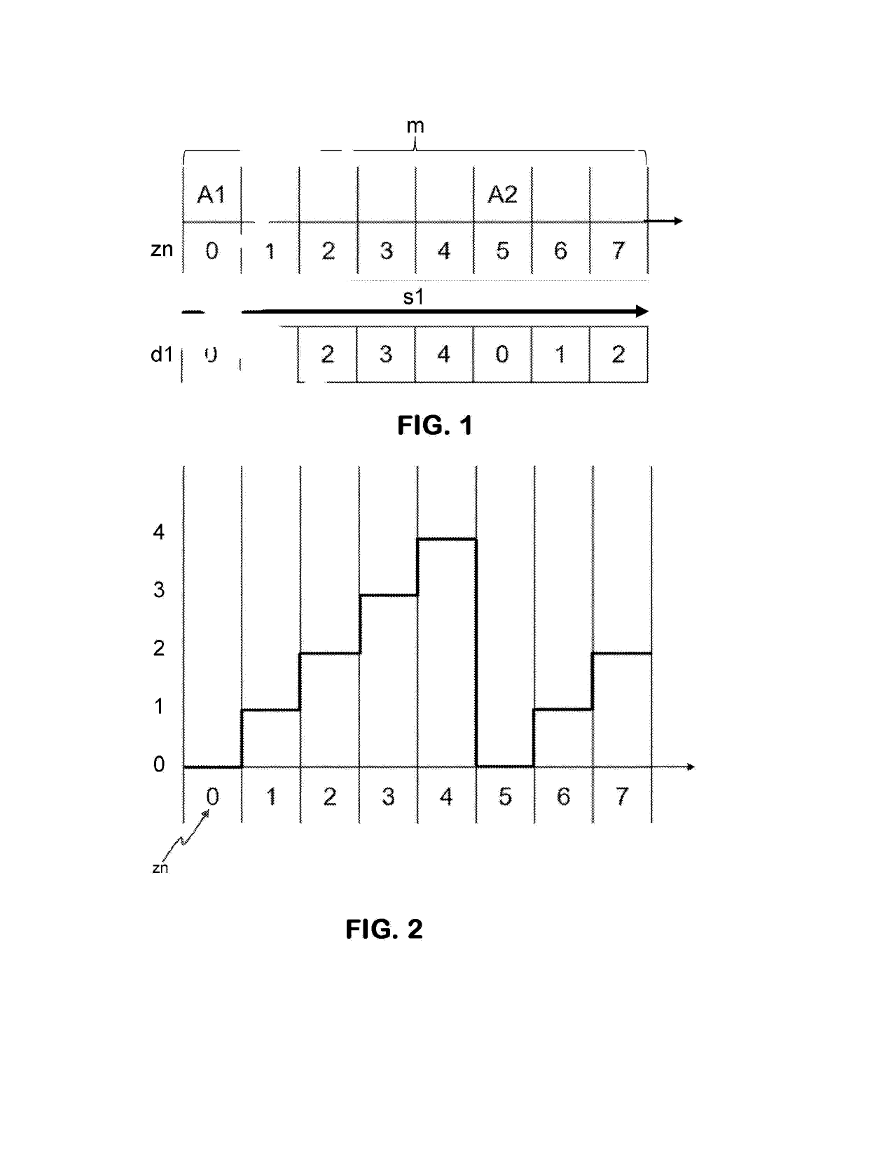

FIG. 1 illustrates an advantageous assignation of time slots in a radio network with synchronization tasks, in particular, a locating network, within a frame m, with a number of n = 8 (0 through 7) time slots zn. According to FIG. 1, the time slot z0 is occupied by an anchor A1 and the time slot z5 is occupied by an anchor A2. The time slot z0 is defined as a start slot. A distance of the occupied time slots zn from one another is counted by a counting loop s1 in a first direction from the slot z0 towards the slot z7, wherein each distance is stored in a first data structure d1. It is evident from FIG. 1 that the counting loop s1 stores a number 0 in the data structure d1 when a time slot (z0, z5) is occupied. Thereafter, the counting loop, s1, is incremented by a value of 1 for each free time slot.

The distances are shown in the diagram according to FIG. 2. According to this embodiment, the time slot z0 has stored the distance 0 in the data structure d1 since the time slot z0 is occupied by the anchor A1. According to the first counting loop s1, the time slot z1 has the distance 1 from the anchor A1, the time slot z2 has the distance 2, the time slot z3 has the distance 3, and the time slot z4 has the distance 4. The distances are stored by an integer-type array. The time slot z5 is occupied the anchor A2 which sets the distance to 0 which is stored in the first data structure d1. Thereafter, a count is performed for the time slots z6 and z7 again, and the distance 1 or the distance 2 is determined and stored.

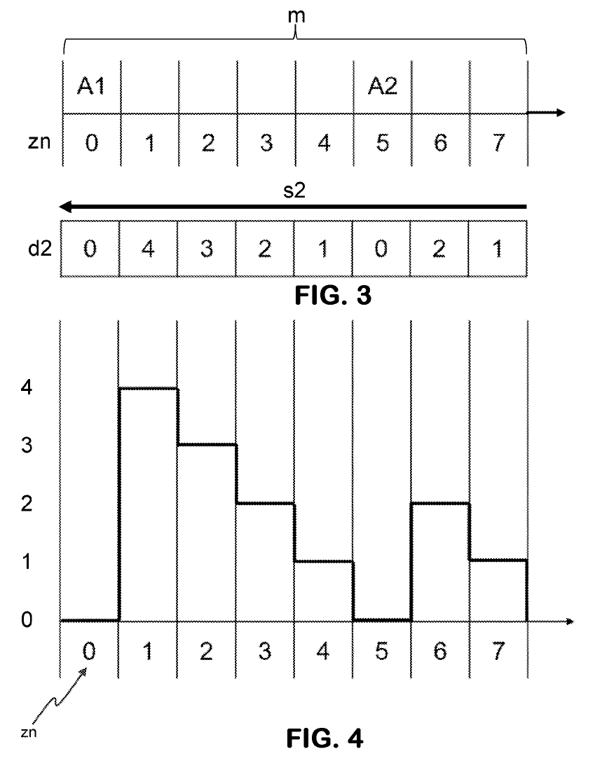

FIG. 3 shows a representation of an occupation of the time slots zn according to FIG. 1 counting in an opposite direction in a second counting loop s2. The determined distances are stored in a second data structure d2. The start time slot is defined as the time slot z7.

Therefore, the count starts from the time slot z7 with the distance 1. The time slot z6 has a distance 2. Since the time slot z5 is occupied by the anchor A2, the distance of this time slot is set to 0.

Thereafter, the distance for the time slots z4 through z0 is determined starting from the time slot z5 in a counting direction of the counting loop s2, wherein the time slot z0 is occupied by the anchor A1 and thus the counting loop s2 is set to 0.

The diagram according to FIG. 4 is determined from the distances that are stored in the second data structure d2. The individual time slots zn are plotted horizontally and a distance to a next occupied time slot zn is plotted vertically. The time slots occupied by the anchors A1, A2 are shown as 0 in the diagram.

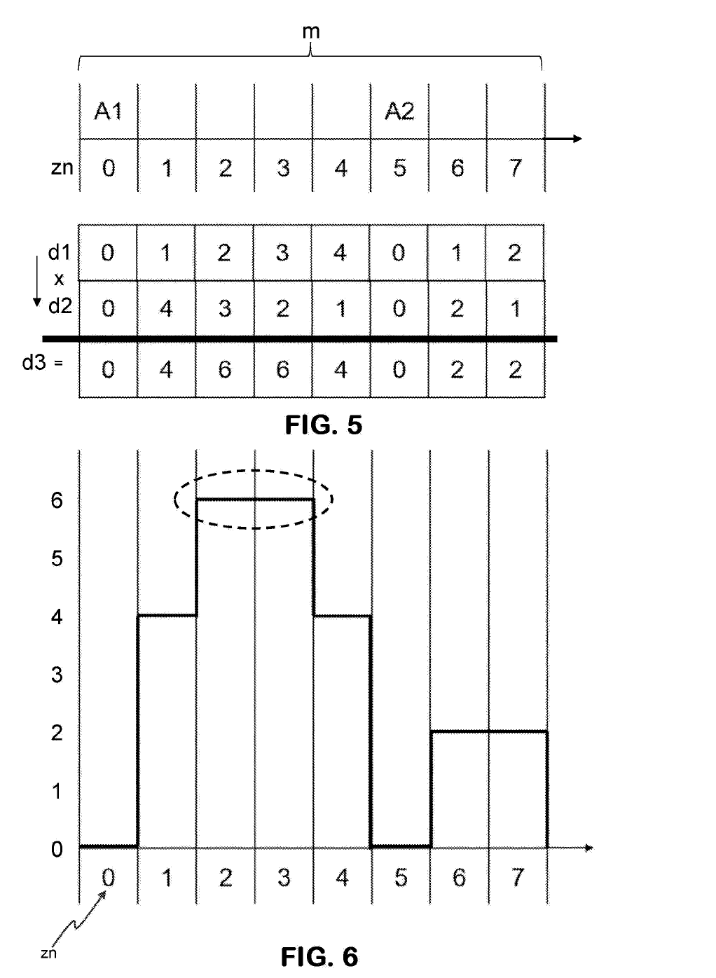

The first data structure d1 and the second data structure d2 is processed according to the invention to determine the optimum time slot according to FIG. 5.

FIG. 5 shows the frame m according to FIGS. 1-4 with the associated first and second data structure d1, d2. The frame m includes the time slots zn (n=0 through n=7). The data structures d1, d2, which were previously determined by the first and second counting loop s1, s2 are multiplied with one another, wherein the product of the values of the first data structure d1 and the second data structure d2 of the individual time slots is stored in a third data structure d3. This yields a value of 0 in the third data structure for the occupied time slots z0 and z5 with the anchors A1 and A2.

A maximum of 6 is obtained from the product of the distances for the time slots z2 and z3. The determined products of the multiplication of the time slots are shown in FIG. 6. This results in the optimum available time slot for a new anchor being the time slot z2 or z3. Since the time slots z2 and z3 have the same value in the third data structure, a random selection of the time slot z2 or z3 can be performed by a new anchor or tag.

The network nodes and other hardware referenced herein include non-transitory computer-readable mediums.

UWB technology is a short-range, low-energy wireless technology that operates across a very broad radio frequency spectrum. Unlike Bluetooth or Wi-Fi, UWB excels at pinpointing the exact physical location of objects in real time with centimeter-to-inch-level accuracy.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

### REFERENCE NUMERALS AND DESIGNATIONS

A1 first anchor
A2 second anchor
d1 first data structure
d2 second data structure
d3 third data structure m frame n number of time slots per frame
s1 first counting loop
s2 second counting loop
zn time slot
z0 time slot 0
z1 time slot 1
z2 time slot 2
z3 time slot 3
z4 time slot 4
z5 time slot 5
z6 time slot 6
z7 time slot 7

What is claimed is:

1. A method for determining time slots in a wireless communication system configured as a radio network performing synchronization tasks, the communication system including plural network subscribers having transmission functionality, the method comprising:
dividing a radio channel provided by the network subscribers into individual time slots (zn) configured to sequentially transmit data, wherein the dividing is performed by a time division multiplexing method of time division multiple access and each time slot (zn) is occupiable by a network subscriber, wherein each network subscriber with transmission functionality includes a slot selector used by the network subscriber to access the divided radio channel in a time coordinated manner;
counting a distance of free time slots (zn) from an occupied time slot (zn) in a first direction from a start time slot in a first counting loop (s1) and storing the respective distance of each time slot (zn) in a first data structure (d1);
counting a distance of free time slots (zn) to an occupied time slot (zn) in a second direction opposite to the first direction in a second counting loop (s2), and associating the respective distance with the time slot (zn) and storing the respective distance in a second data structure (d2);
resetting the counting loops (s1, s2) to a value 0 for an occupied time slot;
multiplying the distances of the individual time slots (zn) stored in the first data structure (d1) and in the second data structure (d2) with each other and storing a product of the multiplication in a third data structure (d3), wherein a maximum value in the third data structure (d3) represents a maximum distance between two occupied time slots (zn); and
putting out a time slot (zn) with a maximum possible distance as a best possible time slot (zn) for data transmission by the network subscriber.

2. The method according to claim 1, wherein the network subscribers are stationary reference stations configured as anchors (A1, A2) and/or moveable objects configured as tags with transmission functionality wherein each anchor (A1, A2) and/or tag includes a proprietary time slot (zn) configured as a transmission point in time and the anchors (A1, A2) and/or tags select a free time slot (zn).

3. The method according to claim 1, wherein the communication system includes network subscribers without the slot selector, configured as tags without transmission functionality.

4. The method according to claim 1, wherein a start time slot for beginning the count is randomly selected.

5. The method according to claim 1, wherein the start time slot for beginning the count is predetermined.

6. The method according to claim 1, wherein an anchor (A1, A2) and/or the tag selects the time slot (zn) which has a maximum value in the third data structure (d3).

7. The method according to claim 6, wherein a random selection of a time slot (zn) with a maximum value is performed in the data structure (d3) when plural maximum values are determined in the third data structure (d3).

8. The method according to claim 1, wherein the first, the second and the third data structure (d1, d2, d3) are integer-type arrays.

9. The method according to claim 1, wherein an occupied time slot (zn) is associated with a value 0 in the data structure.

10. The method according to claim 1, wherein the time slots (zn) are divided into periodically recurring sections configured as frames (m).

11. The method according to claim 1, wherein the radio network with the synchronization tasks is an ultra-wide band network.
